(19) United States
(12) Patent Application Publication
(10) Pub. No.: US 2018/0262034 A1
(43) Pub. Date: Sep. 13, 2018

(54) Power Supply Control System of an Electronic Lock

(71) Applicant: Jao Ching Lin, Taipei City (TW)

(72) Inventor: Jao Ching Lin, Taipei City (TW)

(21) Appl. No.: 15/912,669

(22) Filed: Mar. 6, 2018

(30) Foreign Application Priority Data
Mar. 7, 2017 (TW) 106203195

(51) Int. Cl. H02J 7/00; E05B 47/00

(52) U.S. Cl. CPC H02J 7/0063; E05B 2047/0058; E05B 47/00

(57) ABSTRACT

A power supply control system of an electronic lock has at least two battery packs, a power control module, and a power unit group. The power control module is electrically connected to the at least two battery packs and the power unit group. The power unit group has at least one power unit. Each one of the at least one power unit is supplied electric power by at least one of the battery packs this is selected by the power control module. When the power control module selects at least two battery packs in parallel to supply electric power, and this may provide a dual-powers supplying effect to extend the use time of the electronic lock. Furthermore, when the selected battery pack is flat, the other one of the battery pack may provide an option to select to supply electric power, and this may improve the inconvenience of replacing the battery packs and keeps the electronic lock working when replacing one of the battery packs.

### BACKGROUND OF THE INVENTION

### 1. Field of the Invention

The present invention relates to an electronic lock, and more particularly to a power supply control system of an electronic lock that is disposed in the electronic lock and is used for deploying an internal power of the electronic lock.

### 2. Description of Related Art

A conventional electronic lock has multiple electrical units such as a display, a keyboard, a lock driver, and the like. When the electrical units of the conventional electronic lock are operated, the electricity is supplied by a battery pack that is disposed in the conventional electronic lock. The battery pack generally has four series-connected 1.5 V batteries, and provides 6 V to each one of the electrical units.

Since the conventional electronic lock is supplied electric power by a single battery pack and cannot expand the capacity of the battery pack arbitrarily. When the power of the conventional electronic lock runs out every six months, the battery pack needs to be replaced with a new one. In addition, due to the lack of power supply in the conventional electronic lock during the replacement interval of the battery pack, so the conventional electronic lock is interrupted at this time, cannot set or unlock the conventional electronic lock at this time operation, resulting in the use of convenience. The power supply control system of an electronic lock in accordance with the present invention mitigates or obviates the aforementioned problems.

### SUMMARY OF THE INVENTION

The main objective of the present invention is to provide a power supply control system of an electronic lock that is disposed in the electronic lock and is used for deploying an internal power of the electronic lock.

The power supply control system of an electronic lockin accordance with the present invention has at least two battery packs, a power control module, and a power unit group.

The power control module is electrically connected to the at least two battery packs and the power unit group. The power unit group has at least one power unit. Each one of the at least one power unit is supplied electric power by at least one of the battery packs this is selected by the power control module. When the power control module selects at least two battery packs in parallel to supply electric power, and this may provide a dual-powers supplying effect to extend the use time of the electronic lock.

Furthermore, when the selected battery pack is flat, the other one of the battery pack may provide an option to select to supply electric power, and this may improve the inconvenience of replacing the battery packs and keeps the electronic lock working when replacing one of the battery packs.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a preferred embodiment of a power supply control system of an electronic lock in accordance with the present invention; and

FIG. 2 is a block diagram of a battery pack of the power supply control system of the electronic lock in FIG. 1.

### DETAILED DESCRIPTION OF THE PREFERRED EMBODIMENT

In order to understand the technical features and effects of the present invention in detail, and in accordance with the contents of the specification, the preferred embodiments shown in the figures are further described in detail as follows.

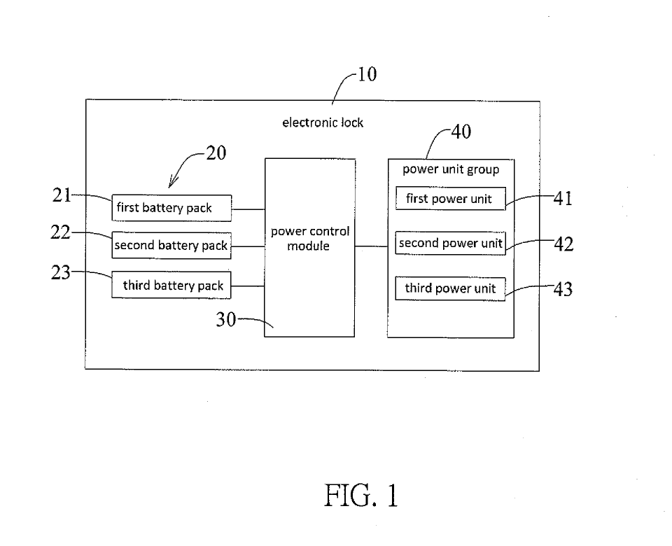

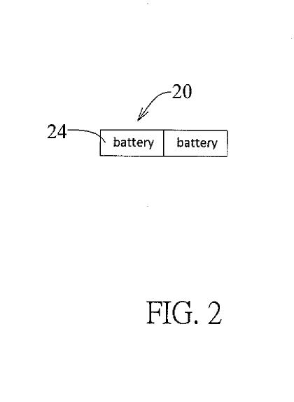

With reference to FIGS. 1 and 2, a preferred embodiment of a power supply control system of an electronic lock 10 in accordance with the present invention has three battery packs 20, a power control module 30, and a power unit group 40.

The three battery packs 20 are respectively a first battery pack 21, a second battery pack 22, and a third battery pack 23. The three battery packs 20 are electrically connected to the power control module 30. Each one of the battery packs 20 has two batteries 24 in series, and each one of the two batteries has voltage of 3V. Each one of the first battery pack 21, the second battery pack 22, and the third battery pack 23 can provide power of 6V, respectively. The power control module 30 is electrically connected to the power unit group 40. The power unit group 40 has a first power unit 41, a second power unit 42, and a third power unit 43.

The first power unit 41, the second power unit 42, and the third power unit 43 are supplied electric power by at least one of the battery packs 20 that is selected by the power control module 30. When the power control module 30 selects at least two of the battery packs 20 in parallel to supply electric power, when at least one of the battery packs 20 is flat, for example, when the first battery pack 21 is flat, the power control module 30 selects the second battery pack and the third battery pack 23 to supply electric power to the first power unit 41, the second power unit 42, and the third power unit 43. Furthermore, when the first battery pack 21 and the second battery pack 22 are flat, the power control module 30 selects the third battery pack 23 to supply electric power to the first power unit 41, the second power unit 42, and the third power unit 43.

In the foregoing preferred embodiment of the present invention, the first power unit 41, the second power unit 42, and the third power unit 43 are supplied electric power from the three battery packs 20 that is selected by the power control module 30. There are at least the following categories:

First, the first power unit 41, the second power unit 42, and the third power unit 43 are supplied electric power from the same battery pack 20 that is selected by the power control module 30, such as the first battery pack 21, the second battery pack 22 or the third battery pack 23. When the selected battery pack 20 is flat, for example, the first battery pack 21 is selected to supply electric power to the first power unit 41, the second power unit 42, and the third power unit 43 of the power unit group 40. When the first battery pack 21 is flat, the power control module 30 selects one of the second battery pack 22 and the third battery pack 23 to supply electric power to the first power unit 41, the second power unit 42, and the third power unit 43 of the power unit group 40.

Second, the power control module 30 selects all of the battery packs 20 to supply electric power to the first power unit 41, the second power unit 42, and the third power unit 43, including the first battery pack 21, the second battery pack 22, and the third battery pack 23 that are connected to each other in parallel.

Third, the number of the first battery pack 21, the second battery pack 22, and the third battery pack 23 is same as the number of the first power unit 41, the second power unit 42, and the third power unit 43, the power control module 30 selects one of the battery packs 20 to supply electric power to each one of the first power unit 41, the second power unit 42, and the third power unit 43 by a non-repeating manner. For example, the first power unit 41 is supplied electric power by the first battery pack 21, the second power unit 42 is supplied electric power by the second battery pack 22, and the third power unit 43 is supplied electric power by the third battery pack 23.

In the preferred embodiment of the present invention, the electronic lock has three battery packs 20, and the power unit group 40 has the first power unit 41, the second power unit 42, and the third power unit 43. The number of the battery pack 20 may be set two or more than two, and the number of the power unit group 40 may be one, such as the first power unit 41, may be two, such as the first power unit 41 and the second power unit 42, or may be more than three, such as the first power unit 41, the second power unit 42, the third power unit 43, and other power units. In the present invention, the numbers of changes are not limited herein.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

LISTING OF REFERENCE NUMBERS

| | | | |
|---|---|---|---|
| 10 | electronic lock | 20 | battery packs |
| 21 | first battery pack | 22 | second battery pack |
| 23 | third battery pack | 24 | battery |
| 30 | power control module | 40 | power unit group |
| 41 | first power unit | 42 | second power unit |
| 43 | third power unit | | |

What is claimed is:

1. A power supply control system of an electronic lock having at least two battery packs disposed in the electronic lock, a power control module disposed in the electronic lock and a power unit group disposed in the electronic lock, wherein
the at least two battery packs are electrically connected to the power control module respectively, the power control is electrically connected to the power unit group, and the power unit group has at least one power unit, each one of the at least one power unit is supplied electric power by at least one of the battery packs that is selected by the power control module;
the power control module uses two or more battery packs to supply electric power, the selected battery packs are connected to each other in parallel, when at least one of the selected battery packs is flat, the remaining functional at least one of the selected battery packs is selected by the power control module to supply electric power to each one of the at least one power unit.

2. The power supply control system of an electronic lock as claimed in claim 1, wherein the electronic has two battery packs, and each battery pack has two batteries in series.

3. The power supply control system of an electronic lock as claimed in claim 1, wherein the electronic lock has four battery packs, and each battery pack has two batteries in series.

4. The power supply control system of an electronic lock as claimed in claim 1, wherein each power unit is supplied electric power by a same battery pack that is selected by the power control module and the selected battery pack is flat, then one of the remaining battery packs is selected by the power control module to supply electric power to each power unit.

5. The power supply control system of an electronic lock as claimed in claim 2, wherein each power unit is supplied electric power by a same battery pack that is selected by the power control module and the selected battery pack is flat, then remaining functional one of the battery packs is selected by the power control module to supply electric power to each power unit.

6. The power supply control system of an electronic lock as claimed in claim 3, wherein each power unit is supplied electric power by a same battery pack that is selected by the power control module and the selected battery pack is flat, then remaining functional one of the battery packs is selected by the power control module to supply electric power to each power unit.

7. The power supply control system of an electronic lock as claimed in claim 1, wherein the power control module selects at least two of the battery packs in parallel to supply electric power to each power unit.

8. The power supply control system of an electronic lock as claimed in claim 2, wherein the power control module selects at least two of the battery packs in parallel to supply electric power to each power unit.

9. The power supply control system of an electronic lock as claimed in claim 3, wherein the power control module selects at least two of the battery packs in parallel to supply electric power to each power unit.

10. The power supply control system of an electronic lock as claimed in claim 1, wherein the number of the at least two battery packs is same as the number of the at least one power unit, and the power control module selects one of the at least two battery packs to supply electric power to each one of the at least one power unit by a non-repeating manner.

11. The power supply control system of an electronic lock as claimed in claim 2, wherein the number of the at least two battery packs is same as the number of the at least one power unit, and the power control module selects one of the at least two battery packs to supply electric power to each one of the at least one power unit by a non-repeating manner.

12. The power supply control system of an electronic lock as claimed in claim 3, wherein the number of the at least two battery packs is same as the number of the at least one power unit, and the power control module selects one of the at least two battery packs to supply electric power to each one of the at least one power unit by a non-repeating manner.
